(19) United States
(12) Patent Application Publication
(10) Pub. No.: US 2006/0047662 A1
(43) Pub. Date: Mar. 2, 2006

(54) Capability support for web transactions

(76) Inventors: Rajkishore Barik, New Delhi (IN); Manish P. Kurhedar, Nagpur (IN)

Correspondence Address: Frederick W. Gibb, III;McGinn & Gibb, PLLC, Suite 304, 2568-A Riva Road, Annapolis, MD, 21401, US

(21) Appl. No.: 10/930,597

(22) Filed: Aug. 31, 2004

(51) Int. Cl. G06F 17/30

(52) U.S. Cl. 707/10

(57) ABSTRACT

A resource locator (such as a URL or similar reference) incorporates encrypted control information that is structured according to a predetermined format suited to a particular application. The control information is determined from the resource locator, and the resource locator is then processed in accordance with the control information. A response to a requested resource locator is returned.

### FIELD OF THE INVENTION

The present invention relates to capability support for Web transactions.

### BACKGROUND

“Site jumping” and “back button” issues are problems for many e-commerce applications that run on World Wide Web sites. Users are required to interact with pages of a Web site in a particular sequence to conduct a valid transaction. Existing measures responding to these issues typically depend upon a client browser, which can be compromised to violate the integrity of the Web site.

Current authentication measures used in Web servers are usually implemented using an access control mechanism. Access control lists tabulate user names and their associated passwords. An application server matches the user name and passwords given by users with those stored in the access control list. Such access control based mechanisms do not scale properly to applications that require more complicated or sophisticated functionality.

One attempt to address the limitations of using user names and passwords is outlined in U.S. Pat. No. 5,991,802, issued Nov. 23, 1999 to Microsoft Corporation and entitled “Method and system for invoking methods of objects over the internet”. This reference describes a client computer system that invokes a function of an object of an object class provided by a server computer system. The client sends a request to the server that comprises a Uniform Resource Locator (“URL”) that identifies a script, an object class, and a function of the object class to invoke. The server starts the script and transfers control to the script in response to receiving the request.

The script instantiates an object of the object class identified in the URL of the received request and invokes the function identified in the URL. The invoked function performs the behavior of the function, creates a response to be sent to the client browser, and sends the response to the client browser. The response contains state information describing a state of an object after the behavior of the function is performed. When the client browser subsequently sends a request to invoke a function of the object class, the state information is included in the request, so that the function can operate based on the state information. The “state-full” described in this reference is helpful in many contexts, but provides only a basic level of processing capability, especially for Web-based applications.

A need consequently exists for an improved manner of conducting transactions on electronic networks.

### SUMMARY

The techniques described herein enable a Web server to provide controlled access to resources on Web sites. Out-of-order operations can be prevented in a transaction, thus providing a distributed authentication mechanism. Access controls can be implemented across multiple administrative domains. Ordered access to the resources of the Web site can be ensured, so that the client browser is restricted to accessing the resources in a particular sequence.

A resource locator (such as a uniform resource locator—URL—or similar reference) is received, incorporating control information that is structured according to a predetermined format. The control information is determined from the resource locator, based upon the predetermined format. Multiple formats can be used, each of which is suited to a particular type of request or transaction offered by a particular Web site. The resource locator is processed in accordance with the incorprated control information, which governs how the request for the resource locator is processed. The system can then respond to the requested resource locator.

The control information may specify such details as validity of a resource located for only a particular number of a resource located “clicks”, for a given time period, or for a certain number of transactions. Similarly, the control information may specify that only certain details are to be accessed, or only accessed in a particular order. The restrictions encoded in the control information are tailored to suit a particular application.

The described techniques can be implemented “transparently” between the Web server and the application server, and can be incorporated into the operation of existing Web sites without substantial modification.

### DESCRIPTION OF DRAWINGS

FIG. 1 is a schematic representation of components of a gateway CGI component that implements the capability support features described herein.

FIG. 2 is a flow chart of steps involved in processing Type 1 URLs that incorporate access control information.

FIG. 3 is a flow chart of steps involved in process Type 2 and 3 URLs that incorporate access control information.

FIG. 4 is an event-trace for an example gateway CGI component of the type described with reference to FIG. 1.

FIG. 5 is a schematic representation of a computer system suitable for use in performing the techniques described herein.

### DETAILED DESCRIPTION

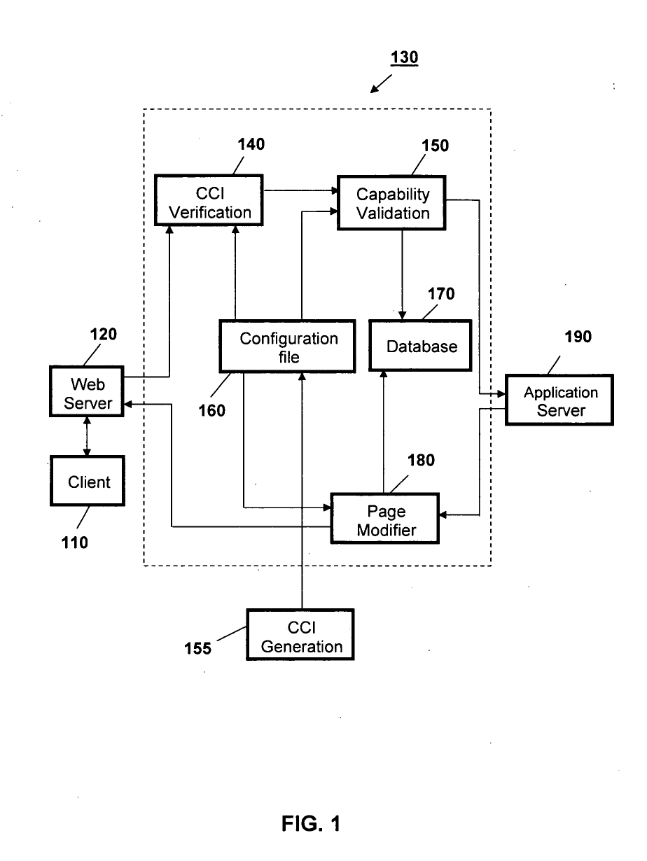

FIG. 1 schematically represents a gateway CGI component 130 incorporated into an existing Web server architecture. The gateway CGI component 130 operates between the Web Server 120 and the Application Server 190. The gateway CGI component 130 modifies an existing Uniform Resource Locator (URL) structure to incorporate capability control information (CCI), and also verifies the “capabilities” encoded in the URL when presented to the gateway CGI component 130.

Capabilities are embedded in the described URLs using CCI. These capabilities can include: validity for only a particular number of “clicks”, validity for a given time period, validity for certain number of transactions, authorization to access particular resources, and the order in which such resources are accessed. A variety of capabilities can be specified and processed, as required.

A capability consists of a collection of “rights” to user transactions. The CCI can be securely encrypted to ensure that the capability cannot be reconstructed. One way of achieving this is to ensure that the CCI carries the checksum of the URL, thereby preventing users from tampering with or forging the CCI incorporated in a URL.

Possession of URLs incorporating CCI is taken as a prima facie evidence that a user may perform the transaction in the ways, and in only the ways, described by the CCI. URLs incorporating CCI can be signed, and encrypted, and hence are not susceptible to “forging”.

CCI can be encoded in the following manner: each resource available from an Application Server 190 via a Web site has a capability associated with the source. Capabilities may be represented in binary form, mainly as binary 1 or 0. Binary “1” implies that the resource can be accessed, whereas binary “0” indicates that the resource cannot be accessed. Only if the capabilities specified by the CCI incorporated in the URL are a superset or equal set of the capabilities of the resource the URL is referencing is the Client 110 allowed to access the resource. If a resource has an associated capability, and the Client 110 does not have the required capability specified in the CCI incorporated in the relevant URL, then the request is not processed as requested by the URL.

Accordingly, Web site A can generate capability-based secured URLs (that is, incorporating CCI) and distribute such URLs to its users. These users can then present these secured URLs at Web site B. The capability-based URLs carry control information that is required at Web site B.

The gateway CGI component 130 imposes capability restrictions with the help of a back-end Database 170 and a Configuration file 160. Instead of the Web Server 120 forwarding a requested resource specified in the URL directly to the Application Server 190, the request is sent to the gateway CGI component 130 that ensures that any relevant “capability” is not violated, with reference to the CCI encoded in the URL initially presented by the Client 110.

After determining that there is no capability violation, the gateway CGI component 130 removes the incorporated CCI from the URL, and redirects the now modified “regular” URL to the Application Server 190. Conversely, gateway CGI component 130 intercepts all the result pages from Application Server 190 and modifies hyperlinks contained in the URLs to incorporate CCI, as appropriate. The gateway CGI component 130 is “invisible” to both the Application Server 190 and the Web Server 120. This approach can thus provide transaction capabilities that span across multiple administrative domains.

Each URL request, which may be a regular URL or a URL incorporating CCI, is first presented to the Web Server 120. The Web Server 120 checks whether or not the resource to which the Client 110 requests access is to be served without capability control restriction. If the Client 110 requests access to a resource that has an associated capability, but the URL request is not a URL that incorporates any CCI, then the Web Server 120 returns an error page to the Client 110 after logging the request for further debugging. Normal URL requests are directly presented to the Application Servers 190. The capabilities for various resources are stored in the Configuration file 160, which is accessible to the gateway CGI component 130. This gateway CGI component 130 executes on the Web Server 120. However, gateway CGI component 130 could also execute on the Application Server 190, or anywhere in between the Web Server 120 and Application Server 190.

The Application Server 190 performs back-end processing and returns the resulting page. On the other hand, if the Web Server 120 is presented with a URL incorporating CCI then the Web server 120 invokes gateway CGI component 130 with the URL for further processing of the CCI.

The gateway CGI component 130 takes URLs incorporating with CCI as input from the Web Server 120, and performs specific processing. The violation of capability restriction sends an error page to the Web Server 120 and logs the request for future debugging. Instead, if the capability is not violated, the requested URL excluding the CCI is forwarded to the Application Server 190 for further transaction-based processing.

Once the processing is complete, the Application Server 190 returns the result page to the gateway CGI component 130. All the hyperlinks in this result page are modified to incorporate the appropriate CCI. Modification is performed by Page Modifier 180, which modifies the hyperlinks to incorporate the CCI and state information to make the hyperlinks Type-2 URLs. Finally, the modified result page is sent back to the Client 10 through the Web Server 120.

The gateway CGI component 130 can be implemented as a CGI script, or a Java Servlet, and can be incorporated into existing Web Servers 120 in the same way as other components. The gateway CGI component 130 can execute within the Web Server 120 or with an intermediate server which intercepts the requests from the Web Server 120 to Application Server 190 or may execute as a front interface to Application Server 190.]

Encoding of CCI in URLs

The CCI incorporated in URLs encodes control information specific to a particular application. In the context of Web-based transactions, examples that arise for typical applications include: the number of transactions for which the URL is valid, the duration for which the URL is valid, the capability information indicating the resources that can be accessed, and the cryptographic pattern used. The URLs are secure by adding cryptographic patterns, which may for example be simple checksums. The actual information incorporated is specific to each particular application, though many applications may use similar control information due to the commonality of such applications.

Table 1 below presents the respective formats of three types of URLs incorporating CCI, each of which is further described below. Type 1 URLs have the capability to initiate a new transaction at a different Web site (possibly a different administrative domain). Type 2 URLs are used to continue an ongoing transaction. Type 3 URLs incorporate special “auto-load” URLs such as inline images (IMG-SRC in the HTTP Hypertext Transport Protocol), and pages with frames.

TABLE 1

Type 1 URLs - InitialURL
<Protocol>://<Domain-name>/<gc-path>/<Document-
path>/<Capabilities>/<IssuerID>/<Generation-Time>/<Max-Age>
/<Number-of-accesses>/1/<Cryptographic-authentication>
Type 2 URLs - Ongoing-Transcation-URL
<Protocol>://<Domain-name>/<gc-path>/<Document-
path>/<Expiry-Time>/ <Transaction-Index>/ <Transaction-
State>/2/<Cryptographic-authentication>
Type 3 URLs - SRC-Transaction-URL
<Protocol>://<Domain-name>/<gc-path>/<Document-path>/
<Expiry-Time>/ <Transaction-Index>/ <Transaction-
State>/3/<Cryptographic-authentication>

Common to all types of URL is the “Protocol” field, which refers to the relevant protocol used to communicate over the Internet, such as, HTTP, HTTPS, SHTTP or FTP. The “Domain-Name” field refers to a sequence of domain labels separated by periods (“.”). As is usual, each domain label starts and ends with an alphanumeric character and possibly also contains the dash (“-”) character. The “gc-path” field refers to the location of the gateway CGI component 130 on the Web Server 120, while the “Document-Path” field refers to the path at which the file can be accessed. The “1”, “2” or “3” fields are used to distinguish between the respective types of the URLs. Each of these types of URLs are described in further detail below.

Type 1 URLs

Type 1 URLs with CCI are initial URLs generated at the Web Server 120. Type 1 URLs are used, for example at the start of a transaction. These URLs can be distributed to all Clients 110 or only particular Clients 110.

The “Generation-Time” and “Max-Age” fields establish when the URL “expires”, namely the time indicated by the combination of “Generation-Time” and “Max-Age” fields, after which the resources indicated by the URL cannot be accessed. The “Number-of-accesses” field refers to the number of transactions for which the URL is valid. Again, the resources indicated by the URL cannot be accessed after the specified number of previous accessed.

The “Capabilities” field is a string of binary bits specifying the capabilities of the URL. An administrator of the Web Server 120 can specify the required capabilities of the various resources of the Web Server 120 in the Configuration file 160. Only if the capabilities of the URL are a superset of the capabilities required to access a particular resource is the request serviced.

The “IssuerID” field is the User Identifier of the Web Server 120, which issued/generated this URL incorporating CCI. The “Cryptographic-authentication” field is used to discourage users from tampering with the URL, as the field cannot readily be duplicated, except with extraordinary effort. The “Cryptographic-authentication” field can either be based upon secret key encryption or a keyed hash. Since secret key encryption requires message authentication the system need not encrypt the URL, and hence a keyed hash is preferred for performance reasons. The intention is to defeat a malicious user who may wish to forge the URLs, and hence along with the CCI, cryptographic patterns are added to the URL. One such example of cryptographic pattern is a checksum, which is appended along with the URL. This avoids malicious users forging the URL. A malicious user may modify the URL by changing the expiry date or other items that appear in the URL, though this measure prevents successful use of a URL so modified.

The key used in the case of keyed hash encryption is a shared key, which the issuer/generator of the URL incorporating CCI shares with the Web Server 120 that responds to the URL from the Client 110, as described above.

Type 2 URLs

Type 2 URLs are used for “ongoing transactions”. Type 2 URLs incorporate CCI that indicates to the gateway CGI component 130 which transaction is being referred to in the Database 170, and the status of the transaction. The Type 2 URLs have a field, “Transaction-Index”, which is the index of the corresponding entry in a field of the Database 170, so that when these URLs are clicked, the links can be referenced to the correct entry in the Database 170. The “Expiry-Time” field indicates the time at which the current transaction is aborted or invalidated.

The “State” field represents the state of the ongoing transaction. Initially, when the transaction starts, the “state” of the Database 170 is 0. For each subsequent transition of the transaction (involving subsequent accesses by the Client 110), the state is incremented accordingly. This state value is stored in the Type 2 URLs, so that when these Type 2 URLs are clicked, a verification is made with the Database field 170 that the state of the URL matches the state of the Database 170. The Client 110 can thus be constrained to accessing URLs only in a particular order. If the client 110 attempts to “save” the URL proceed with the transaction, and wanted to use the saved URL at a later time, the state of the URL will not match the state stored in the Database 170, and the request will be processed accordingly, generating a suitable error.

In Type 2 URLs with CCI, the keyed hash is performed by a local key known only to the Web Server 120 where the transaction is performed.

Type 3 URLs

Type 3 URLs are used for source (“SRC”) requests from Clients 110. These URLs are also generated when the URL is a SRC request. These SRC requests can be due to images, image maps, server-side include, and other such requests made using HTTP. The format of Type 2 and Type 3 URLs is the same. When a Type 3 URL is requested, however, the state in the Database 170 is not incremented, as logically the transaction has not progressed to a new state—instead more pages are requested in the same state. These URLs are present on pages of ongoing transactions.

Subcomponents of the Gateway CGI Component

FIG. 1 schematically represents various subcomponents of gateway CGI component 130 and their interaction. The gateway CGI component 130 has the following internal subcomponents:
CCI Generation component 155 converts a regular URL into a URL incorporating CCI that is subsequently presented to the gateway CGI component 130 for authentication.
CCI Verification component 140 checks the authenticity of the CCI incorporated in the URL. This ensures that the URL is not tampered with after the URL is provided by the CCI Generation component 155.
Capability Validation component 150 checks if the CCI incorporated in the URL has the required capability to access the resources referred to in the URL.
Page Modifier component 180 incorporated suitable CCI into the URLs embedded as hyperlinks of each result pages received from the Application Server 190.
Configuration file 160 is a static configuration file that contains capability information about the resources at the Web Server 120.
Database 170 is used for storing data relating to capabilities and the status of current transactions. Database 170 also contains information regarding various current transactions such as their state, number of parallel connections, time to expire etc.

The Web Server 120 first presents URLs incorporating CCI to the CCI Verification component 140. The CCI Verification component 140 checks the data integrity of the URL and feeds to the Capability Validation component 150. Capability Validation component 150 verifies all the capability restrictions and forwards the request to the Application Server 190 for processing. Finally the result page from Application Server 190 is modified by Page Modifier component 180 and is sent to the Client 110 through Web Server 120. Individual components of gateway CGI component 130 are described further in detail below.

CCI Generation

The CCI Generation component 155 interacts with the Configuration file 160, and does not participate in the ordinary transaction processing functions of the gateway CGI component 130. The CCI Generation component 155 of the gateway CGI component 130 generates URLs with CCI, which are distributed to Clients 110 through various possible channels. Examples include advertising links on web pages or emails. In other words, the CGI Generation component 155 generates Type 1 URLs with CCI. Given a normal URL, this CCI Generation component 155 includes the following capability information: validity for a given time period, validity for certain number of transactions, authorization to access some resources from the Web Server 120. The CCI Generation component 155 then encrypts the message.

In the case of multi-site interaction, a key is shared between two Web Servers 120. This key is supplied in a Configuration file 160 with CCI concerning the resources able to be accessed. Other CCI such as validity period, and valid number of transactions, are also specified in the Configuration file 160 as CCI. All this information is encoded in the Type 1 URLs, and then encrypted using the shared key between the two Web Servers 120.

CCI Verification

Every request containing a URL incorporating CCI that is presented to the gateway CGI component 130 is first verified by the CCI Verification component 140. That is, if the URL incorporating CCI is generated by one Web Server 120, a private key is used to decrypt and ensure that the content is not tampered with by users. If the URL with CCI is issued by another Web Server 120 in an unrelated administrative domain, then a shared key can be used to decrypt and check that the data is authentic. The key on which to perform the decryption is determined based upon the “IssuerID” field in the URL incorporating the CCI.

If the signature verification fails, an error page is presented to the Client 110 though the Web Server 120. On successful verification, the URL is sent to the Capability Validation component 150.

Capability Validation

Capability Validation component 150 of the gateway CGI component 150 ensures that the CCI incorporated in a URL is not “violated”. The Database 170 stores two database tables (“MainTable” and “VariableTable” of Table 2, described below) and a Configuration file 160 specifying capability information maintained for all the resources of the Web Server 120. The “MainTable” database table contains information pertaining to capabilities, whereas the “VariableTable” database table contains information regarding simultaneous multiple ongoing parallel transactions. Table 2 below presents the contents of the MainTable and VariableTable database tables.

TABLE 2
MainTable

| | | | | | |
|---|---|---|---|---|---|
| URL | GeneratedTime | MaxAge | UID | NumTimesLeft | NumSimmConn |

VariableTable

| | | | |
|---|---|---|---|
| TimeToRemove | State | Capabilities | Back Pointer |

The fields stored in “MainTable” are the “GeneratedTime” (which is time at which the URL with CCI was created), and “MaxAge” (which is the time duration for which this URL is valid) so that the system knows when the URL expires, and thus is able to restrict access to the resources based on time. The “NumTimesLeft” field is also maintained so that the URL may not be used beyond the maximum number of allowed transactions. The User ID (UID) and URL document path are stored to keep a log of which other Web sites generated URLs to access which parts of the Web site. Those external Web sites can then, for example, be charged appropriately according to an agreement between such participating websites.

Information about a current transaction is stored in the “VariableTable” represented in Table 2 above. The basic field in this table is the “State” field. This field indicates the current state of a transaction starting from “0”. The field “Time-to-Remove” refers to the time after which the current transaction (corresponding to this VariableTable entry) is aborted, and removed from the VariableTable. In a Type 2 URL, the value of the “Expiry” field is exactly the value of the “Time-to-Remove” field of the VarableTable database table. The “Back Ptr” field is a foreign key to the corresponding MainTable entry. The VariableTable database table also contains capability information for a particular transaction.

The field “NumSimmConn” in the MainTable of the Database 170 refers to the current number of simultaneous requests made corresponding to a particular entry in the MainTable. This is subject to a maximum of “NumTimesLeft”, namely the, number of transactions left (for the URL). This limit is kept, so that even by flooding the Web Server 120, a user is not able to access transactions beyond a specified limit. That is, in cases where multiple transactions are running at the Application Server 190 corresponding to a single entry in the MainTable, the gateway CGI component 130 permits more requests to pass through the gateway CGI component 130 because of the “NumTimesLeft” field is not decreased by Page Modifier component 180. More than the required number of requests can thus be processed. This field ensures that no more than the maximum number of accesses is allowed.

Page Modifier

After the Application Server 190 performs back-end processing, the resulting page corresponding to the entry in VariableTable is presented to the Page Modifier component 180. The Application Server 190 then parses the whole document and modifies the hyperlinks in the document.

In case the result page is a final page, the Page Modifier component 180 removes the entry corresponding to the ongoing transaction from the VariableTable indicating the end of the transaction. Also, the “NumTimesLeft” field is decremented in the MainTable.

The Page Modifier component 180 also increments the “State” field in the VariableTable before modifying the result documents where the result document is not a final page. This is done to avoid state jumping and back button problems.

The Page Modifier component 180 modifies URLs of hyperlinks in the result page. Given a hyperlink is of type “IMG SRC” or references frames, the Page Modifier component 180 modifies such hyperlinks to a Type 3 URL with CCI. The information required for a Type 3 URL is extracted from the VariableTable. Otherwise, if the hyperlink is not of type “IMG SRC”, then the hyperlink is converted to Type 2 URL with CCI.

The Page Modifier component 180 is aware of simultaneous connections to Client 110 and is capable of relating resulting pages with the corresponding entries in “VariableTable”. Finally, the result page is sent to the Web Server 120.

Configuration File

The Configuration file 160 is a flat static file, which contains capability control information for all the resources of the Web site. The resources can be expressed as regular expressions and the capability information is encoded in binary bit string. The pages that represent final state of the transaction are also specified in the Configuration file 160.

For multiple administrative domain information regarding shared key, time of generation, maxium age, number of transactions for which the URL is valid, and the capability of the URL are provided. This information is used by the CCI Generation component 155 of gateway CGI component 130 to generate URLs with CCI for other domains.

Procedure for Processing URLs

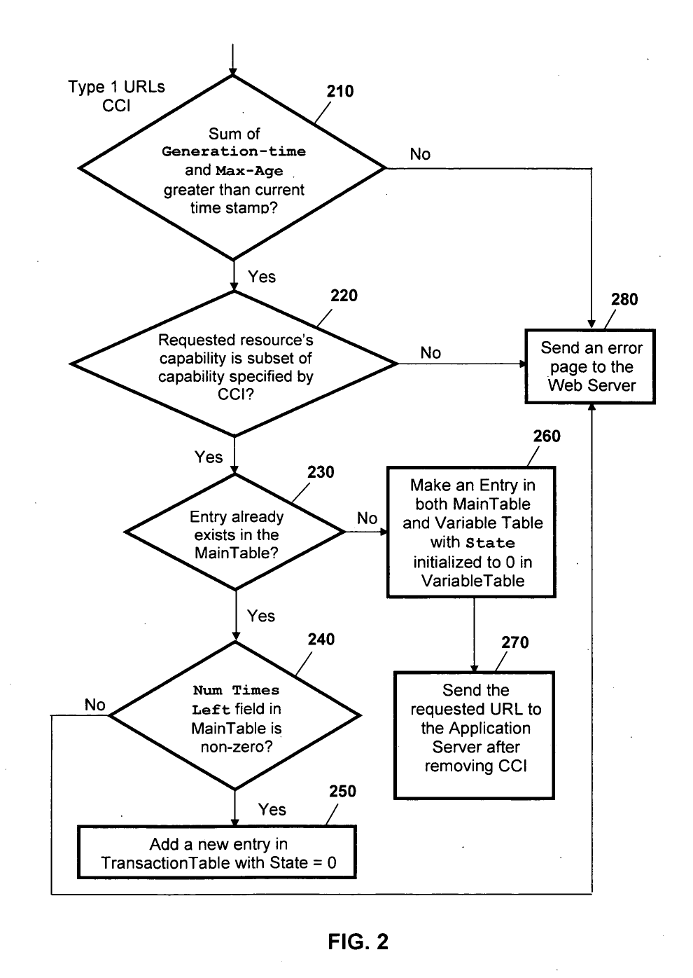

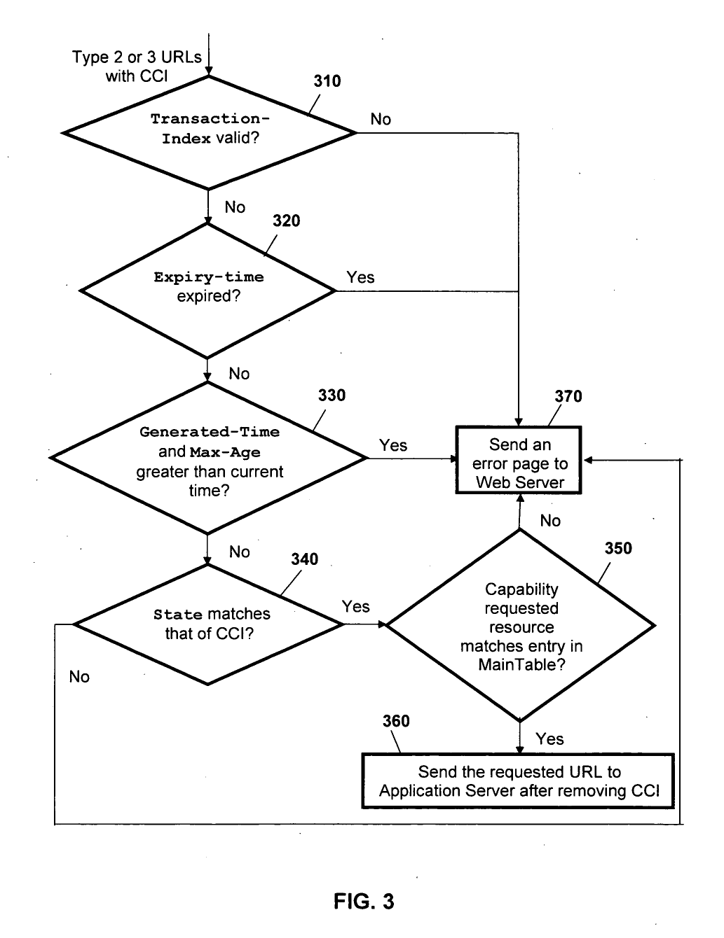

FIG. 2 is a flow chart of steps involved in processing Type 1 URLs, and FIG. 3 is a flow chart of steps involved in process Type 2 and 3 URLs.

When Type 1 URLs with CCI are presented to the Capability Validation component 150, an entry is made in the MainTable with the corresponding entries from requested URL and also an entry to the VariableTable, thereby indicating the start of a transaction. If the same Type 1 URL is clicked again, the URL is only referenced to the same MainTable entry. A new entry is not made. However, a new entry is made in the VariableTable, thus indicating the start of another new transaction, corresponding to the original URL. Therefore, corresponding to each entry in the MainTable, there may be several entries in the VariableTable. This indicates that there are several current parallel transactions corresponding to the same initial Type 1 URL.

Initially, the “state” is set to zero in the VariableTable. Each time a transition is made in the transaction. That is, the next resource in the transaction is requested for, the capability validation increments the value of the state and thus records the status of an ongoing transaction.

When a Type 1 URL incorporating CCl is presented to the Capability Validation component 150, a check is made in step 210 of whether the time at which the URL is presented is less than the sum of values recorded in the “Generation-time” and “Max-Age” fields incorporated in the URL.

A determination is made in step 220 concerning whether a requested resource's capability is a subset of the capability specified by CCI incorporated in the URL. If not, an error is sent to the Web Server in step 280. Otherwise, processing proceeds to step 230.

Having met the conditions of steps 210 and 220, a check is made of whether an entry already exists in the MainTable, in step 230. A determination is then made in step 240 of whether the value of “NumTimesLeft” in MainTable is non-zero. If so, then a new entry is added in the TransactionTable with a value of the “State” field that is zero. If the value of “NumTimesLeft” in MainTable is zero, however, an error is sent to the Web Server 120 in step 280.

If there is no such entry found in step 230, then an entry is made in both the MainTable and VariableTable database tables with a “State” initialised to zero in VariableTable in step 260. Then the requested URL is sent to the Application Server 190, after removing the CCI from the URL.

FIG. 3 is a flow chart concerning Type 2 or 3 URLs. A determination is first made in step 310 of whether “Transaction-index” is a valid index for VariableTable. Next, in step 320, a comparison is made of “expiry-Time” in VariableTable with the time specified in the CCI of the URL. If the time is expired, then an error message is sent to the Web Server in step 370. Otherwise, if the time is valid, then another check is performed with the values of the “GeneratedTime” and “Max Age” fields in the MainTable for the transaction as a whole. An error is sent in step 370 if the time period is not current.

Otherwise, the value of the field “State” in the Type 2 (or Type 3) URL is taken from the “State” field of the VariableTable in step 340 and compared with the value encoded in the CCI of the URL. If there is no match, then an error is sent in step 370. Otherwise, if there is a match, then each time a Type 2 (or Type 3) URL request is received by the Capability Validation component 150 for a particular resource, the capability of the URL stored in the VariableTable is compared to the required capability of the requested resource in step 350. This capability is recorded in the Configuration file 160. Only if the URL has the capability to access the resource is the request serviced in step 360.

When a Type 2 (or Type 3) URL request comes to the Capability Validation component 150 of the gateway CGI component 130, the request serviced only if the “State” field of the URL matches the “State” stored in the Database 170.

The entries in the “MainTable” of the Database 170 remain until the expiry of the URL. After this time, the URL is invalidated, namely after the time indicated by the combination of “Generation-Time” and “Max-Age” expires.

The entry in the “VariableTable” of the Database 170 is removed once the transaction ends. The end of the transaction is indicated by the last node of the transaction. If the last node is a static resource, then all such resources, which correspond to final nodes of transactions, are specified in the Configuration file 160. If, however, the final node is a dynamic resource, the node can have various outputs depending on the input. On one input, the output may be the end of the transaction, and on another input, it can output just another stage in the transaction. Hence, to get dynamic resources to signal an end of transaction, the administrator has to put a METATAG into their output corresponding to the final node.

Example Event Trace

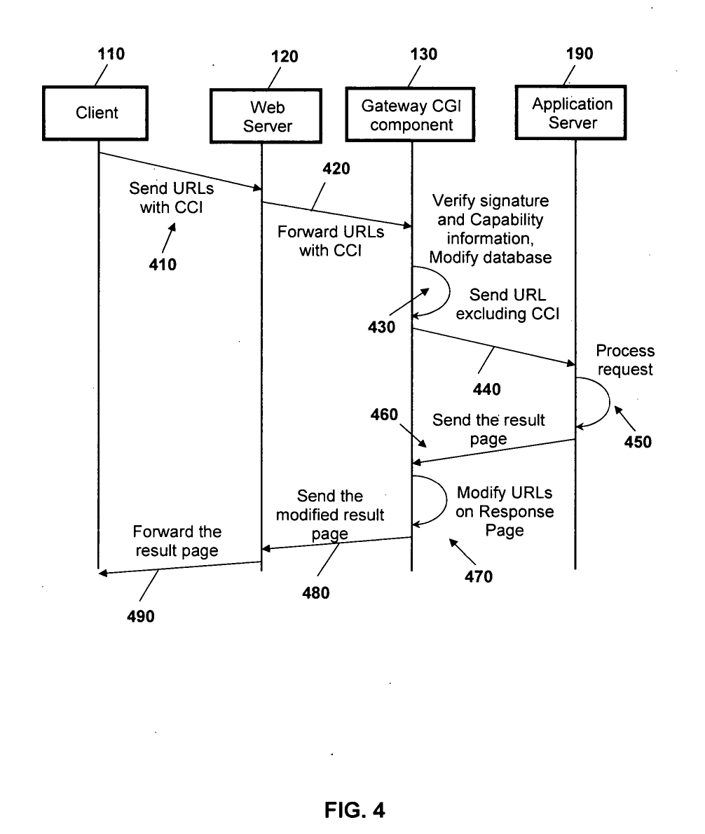

FIG. 4 is an example event-trace for the gateway CGI component 130. A Client 110 first sends a URL with CCI to a Web Server in step 410. The Web Server 120 then forwards the URL with CCI to the gateway CGI component 130 in step 420. The gateway CGI component 130 verifies the signature and capability information and modifies the Database 170 in step 430. Then, the gateway CGI component 130 sends the URL excluding capability “pads” to the Application Server 190 in step 440.

The Application Server 190 processes the request of the URL, in step 450, and sends a response to the gateway CGI component 130 in step 460. The gateway CGI component 130 modifies the URL of the response page from the Application Server 190 in step 470. The gateway CGI component 130 sends the modified page back to the Web Server 120 in step 480. This page is then forwarded back to the client 110 by the Web Server 120 in step 490.

Example Application

Consider a banking transaction, in which an individual “a” having account in bank “B1” wants to transfer some money to another individual “b” who has account in bank “B2”. Bank “B1” and “B2” use a shared key to encrypt any transaction data.

First, “a” requests bank “B1” to give him a capability based URL that incorporates the amount of money to transfer, the user to whom to transfer, namely “b”.

This URL is secured by computing a keyed hash of the URL using the shared key of the two banks and the keyed hash is appended to the resulting URL to prevent any tampering of URL. Responsibility rests with individual “a” to securely pass that URL to “b”. Individual “b” then presents this URL to target bank “B2” which can then verify the integrity of the URL and allow/disallow the transaction. Here, “a” and “b” can use their account numbers as part of the capability control information to further secure the transaction.

Computer Hardware

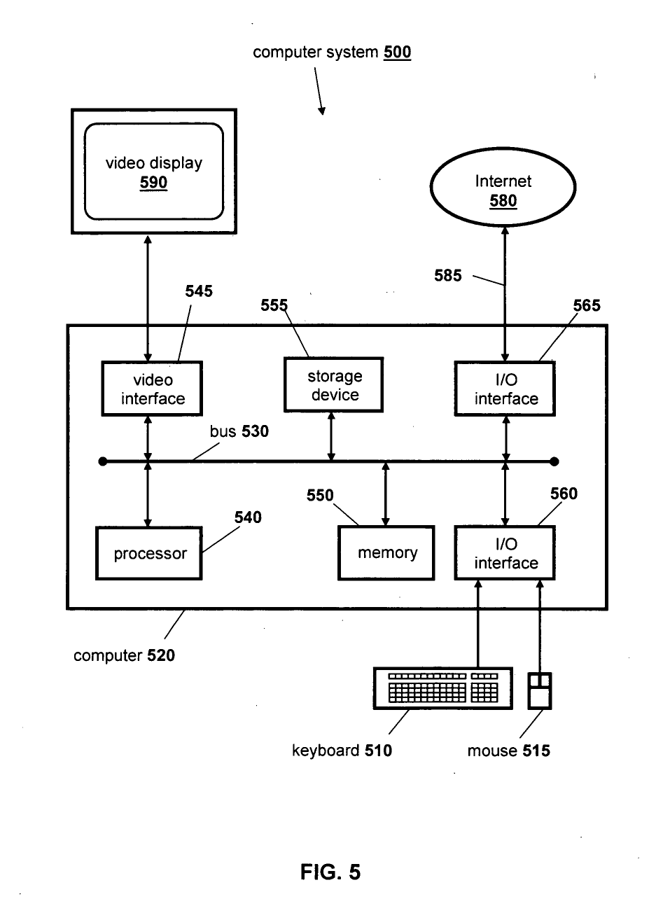

FIG. 5 is a schematic representation of a computer system 500 of a type that is suitable for executing computer software acting as a Client 110, Web Server 120, or Application Server 190. Computer software executes under a suitable operating system installed on the computer system 500, and may be thought of as comprising various software code means for achieving particular steps.

The components of the computer system 500 include a computer 520, a keyboard 510 and mouse 515, and a video display 590. The computer 520 includes a processor 540, a memory 550, input/output (I/O) interfaces 560, 565, a video interface 545, and a storage device 555.

The processor 540 is a central processing unit (CPU) that executes the operating system and the computer software executing under the operating system. The memory 550 includes random access memory (RAM) and read-only memory (ROM), and is used under direction of the processor 540.

The video interface 545 is connected to video display 590 and provides video signals for display on the video display 590. User input to operate the computer 520 is provided from the keyboard 510 and mouse 515. The storage device 555 can include a disk drive or any other suitable storage medium.

Each of the components of the computer 520 is connected to an internal bus 530 that includes data, address, and control buses, to allow components of the computer 520 to communicate with each other via the bus 530.

The computer system 500 can be connected to one or more other similar computers via a input/output (I/O) interface 565 using a communication channel 585 to a network, represented as the Internet 580.

The computer software may be recorded on a portable storage medium, in which case, the computer software program is accessed by the computer system 500 from the storage device 555. Alternatively, the computer software can be accessed directly from the Internet 580 by the computer 520. In either case, a user can interact with the computer system 500 using the keyboard 510 and mouse 515 to operate the programmed computer software executing on the computer 520.

Other configurations or types of computer systems can be equally well used to execute computer software that assists in implementing the techniques described herein.

### CONCLUSION

Various alterations and modifications can be made to the techniques and arrangements described herein, as would be apparent to one skilled in the relevant art.

1-30. (canceled)

31. A method for serving requests for resource locators, said method comprising:
receiving a requested resource locator, which incorporates said control information according to a predetermined format;
identifying said control information incorporated in the received resource locator; and
determining from the identified said control information whether access to said requested resource locator is permitted.

32. The method as claimed in claim 31, further comprising responding to a request with a requested resource if access to a requested resource is permitted.

33. The method as claimed in claim 31, further comprising responding to a request with an error message if access to said requested resource is not permitted.

34. The method as claimed in claim 31, further comprising:
removing said control information from said requested resource locator; and
forwarding said requested resource locator to an application server.

35. The method as claimed in claim 34, further comprising incorporating said control information into at least one resource locator included in a requested resource.

36. The method as claimed in claim 31, wherein said control information specifies at least one of a validity of said resource locator for a particular number of accesses, a validity of said resource locator for a given time period, a validity of said resource locator for certain number of transactions, an authorization to access resources specified by said requested resource locator, and an authorization for a transaction state in which said resource locator can be accessed.

37. The method as claimed in claim 31, wherein said control information specifies different types of predetermined formats for said control information.

38. The method as claimed in claim 34, further comprising maintaining a record of a number of times for which a request for said resource locator is accessed.

39. The method as claimed in claim 34, further comprising maintaining a record of a transaction state in which said resource locator can be accessed.

40. A computer program, recorded on a computer-readable medium, comprising computer software for performing a method comprising:
receiving a requested resource locator, which incorporates said control information according to a predetermined format;
identifying said control information incorporated in the received resource locator; and
determining from the identified said control information whether access to said requested resource locator is permitted.

41. The computer program as claimed in claim 40, wherein said method further comprises responding to a request with said requested resource if access to said requested resource is permitted.

42. The computer program as claimed in claim 40, wherein said method further comprises responding to a request with an error message if access to a requested resource is not permitted.

43. The computer program as claimed in claim 40, wherein said method further comprises:
removing said control information from said requested resource locator; and
forwarding said requested resource locator to an application server.

44. The computer program as claimed in claim 43, wherein said method further comprises incorporating said control information into at least one resource locator included in a requested resource.

45. The computer program as claimed in claim 40, wherein said control information specifies at least one of a validity of said resource locator for a particular number of accesses, a validity of said resource locator for a given time period, a validity of said resource locator for certain number of transactions, an authorization to access resources specified by said requested resource locator, and an authorization for a transaction state in which said resource locator can be accessed

46. The computer program as claimed in claim 40, wherein said control information specifies different types of predetermined formats for said control information.

47. The computer program as claimed in claim 40, wherein said method further comprises maintaining a record of a number of times for which a request for said resource locator is accessed.

48. The computer program as claimed in claim 44, wherein said method further comprises maintaining a record of a transaction state in which said resource locator can be accessed.

49. A computer system comprising computer software recorded on a computer-readable medium for performing:
receiving a requested resource locator, which incorporates said control information according to a predetermined format;
identifying said control information incorporated in the received resource locator; and
determining from the identified said control information whether access to said requested resource locator is permitted.

50. The computer system as claimed in claim 49, wherein said method further comprises responding to a request with said requested resource if access to said requested resource is permitted.

51. The computer system as claimed in claim 49, wherein said method further comprises responding to a request with an error message if access to a requested resource is not permitted.

52. The computer system as claimed in claim 49, wherein said method further comprises
removing said control information from said requested resource locator; and
forwarding said requested resource locator to an application server.

53. The computer system as claimed in claim 52, wherein said method further comprises incorporating said control information into at least one resource locator included in said requested resource.

54. The computer system as claimed in claim 49, wherein said control information specifies at least one a validity of said resource locator for a particular number of accesses, a validity of said resource locator for a given time period, a validity of said resource locator for certain number of transactions, an authorization to access resources specified by said requested resource locator, and an authorization for a transaction state in which said resource locator can be accessed.

55. The computer system as claimed in claim 49, wherein said control information specifies different types of predetermined formats for said control information.

56. The computer system as claimed in claim 49, wherein said method further comprises maintaining a record of a number of times for which a request for said resource locator is accessed.

57. The computer system as claimed in claim 52, wherein said method further comprises maintaining a record of a transaction state in which said resource locator can be accessed.
